(19) United States
(12) Patent Application Publication
(10) Pub. No.: US 2012/0126081 A1
(43) Pub. Date: May 24, 2012

(54) MOUNTING SYSTEM FOR DIGITAL MEDIA PLAYERS

(75) Inventors: Brian Jeffrey Wengreen, Maple Valley, WA (US); Eric John Wengreen, Stanford, CA (US)

(73) Assignee: INNOVELIS, INC., Roseville, MN (US)

(21) Appl. No.: 13/278,759

(22) Filed: Oct. 21, 2011

Related U.S. Application Data
(60) Provisional application No. 61/416,736, filed on Nov. 23, 2010.

(51) Int. Cl. F16M 13/00; B23P 11/00; F16B 45/00

(52) U.S. Cl. 248/304; 29/428

(57) ABSTRACT

An apparatus and a method that allow users to mount digital media players.

### CROSS-REFERENCE TO RELATED APPLICATIONS

This application claims the benefit of U.S. Provisional Application 61/416,736, filed on Nov. 23, 2010 and entitled Mounting System for Digital Media Players. The disclosure of the above application is incorporated herein by reference.

### TECHNICAL FIELD

The present invention is in the technical field of mounting systems. More specifically, the present invention is in the technical field of mounting systems for digital media players.

### BACKGROUND

Users often place digital media players near a television. Television owners desire a convenient means to mount digital media players.

### SUMMARY

We have discovered an apparatus and a method that allow users to mount digital media players.

### DESCRIPTION OF THE DRAWINGS

FIG. 1 illustrates a digital media player.

FIG. 2 illustrates one embodiment of the present invention.

FIG. 3 illustrates a digital media player inside a tray embodiment.

FIG. 4 illustrates round vents, vertical vents, and horizontal vents.

FIGS. 5A and 5B illustrate a circular hook embodiment, which is configured to attach to round vents.

FIGS. 6A and 6B illustrate a vertical hook embodiment, which is configured to attach to vertical vents.

FIGS. 7A and 7B illustrate a horizontal hook embodiment, which is configured to attach to horizontal vents.

FIG. 8 illustrates an embodiment where a back portion slides into a first opening in the tray.

FIG. 9 illustrates an embodiment with a hook in a first opening.

FIG. 10 illustrates cross section A-A from FIG. 9.

FIG. 11 illustrates a side view of cross section A-A from FIG. 9.

FIG. 12 illustrates an embodiment with fastening loops securing a tray.

FIG. 13 illustrates hooks attached to a tray as the tray approaches vents.

FIG. 14 also illustrates hooks attached to a tray as the tray approaches vents.

FIG. 15 illustrates a tray embodiment mounted on a screen by using hooks.

### DESCRIPTION OF THE PREFERRED EMBODIMENTS

The accompanying drawings form part of the detailed description below.

The drawings show specific embodiments in which the invention may be practiced, by way of example or illustration and not by way of limitation. These embodiments are described in enough detail through text and drawing figures to enable those skilled in the art to practice the claimed invention. The embodiments may be combined, other embodiments may be utilized, or structural, logical and mechanical changes may be made without departing from the scope and spirit of the claimed invention. The following description is, therefore, not to be taken in a limiting sense. The description below illustrates implementations of the invention and does not limit the invention.

In the drawings, which are not necessarily drawn to scale, like numerals describe substantially similar components throughout the several views. The drawings illustrate generally, by way of example, but not by way of limitation, various embodiments discussed in this disclosure.

Digital media players include Digital Video Disc (DVD) players, Blu-ray players, and digital media extenders such as Apple TVs. Digital media players often transmit digital signals wirelessly or through a wire such as a High-Definition Multimedia Interface (HDMI) cable to a screen that displays an image based on the digital signal. Screens include computer monitors, televisions, and image-producing portions of movie projectors. Televisions include flat-panel displays, flat-screen televisions, and tube televisions.

Owners of digital media players often prefer to mount their digital media player near their screens. For example, a person who owns a flat screen television that is mounted on the wall might want to mount her Apple TV onto her flat screen television or onto the wall behind her flat screen television.

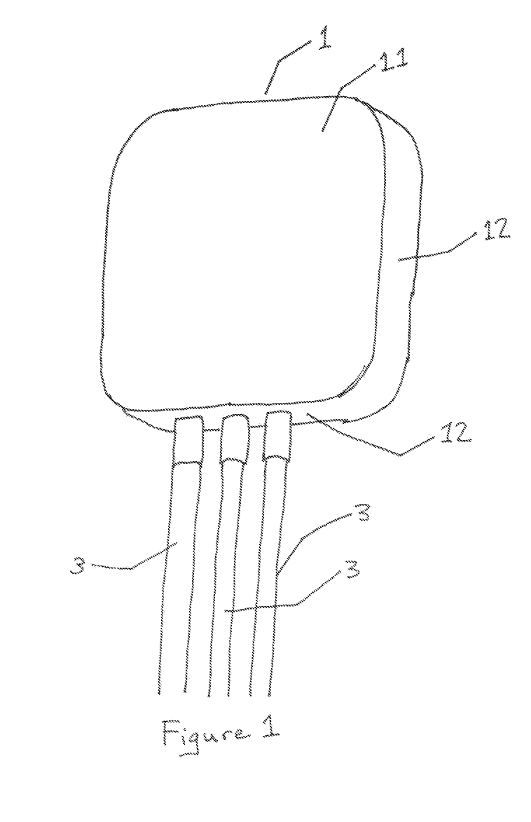

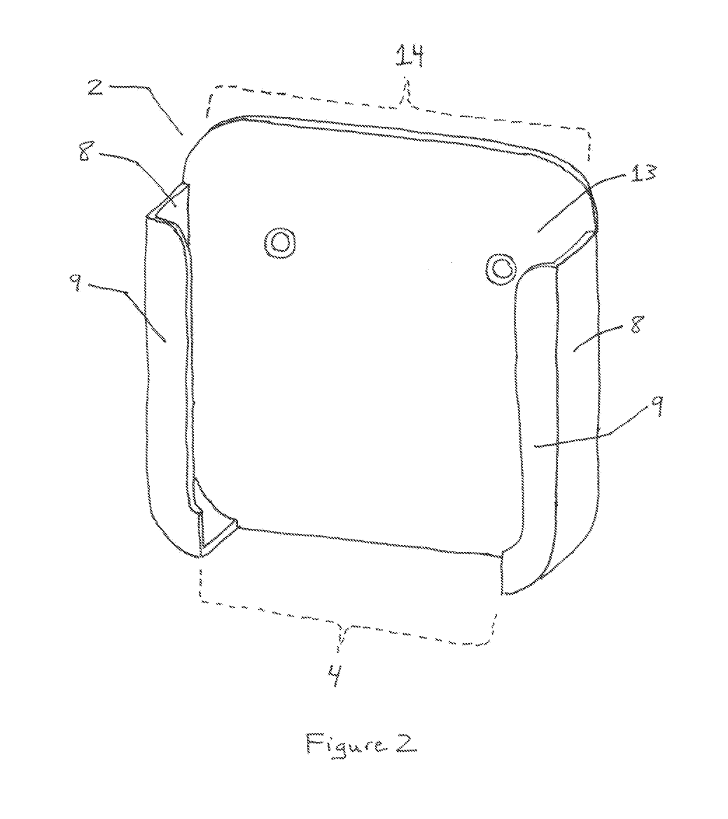

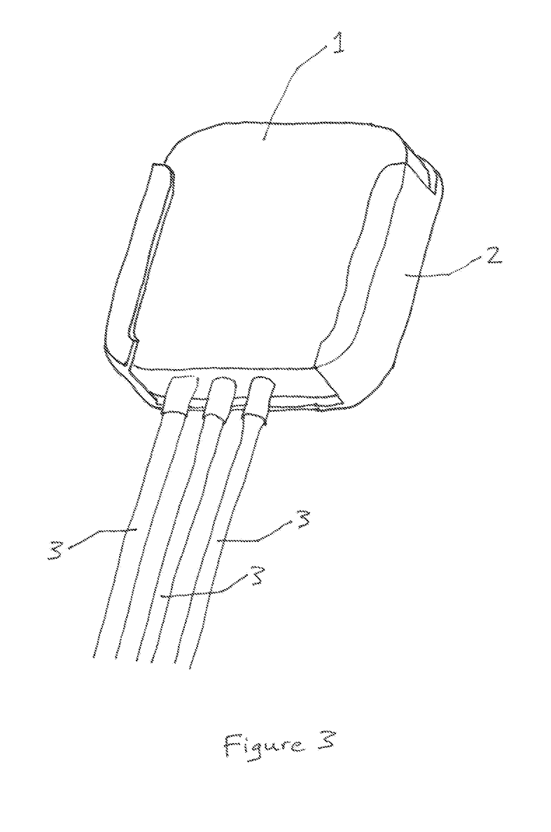

FIG. 1 illustrates a digital media player 1. FIG. 2 shows one embodiment of the present invention. The digital media player 1 slides into a tray 2. FIG. 3 shows the digital media player 1 inside the tray 2.

In one embodiment, the tray 2 is configured such that a user can connect electrical cables 3 to the digital media player 1 and then slide the digital media player 1 into the tray 2 without having to disconnect the electrical cables 3. For example, the tray 3 in FIG. 2 includes an open portion 4 that enables the user to slide the digital media player 1 with attached electrical cables 3 into the tray 2. In one embodiment, the tray 2 does not have sidewalls 8 nor does the tray 2 have retaining lips 9 in the open portion 4. The open portion 4 is located such that the electrical cables 3 exit the digital media player 1 in the open portion 4.

The digital media player has two large sides 11 and four small sides 12. In one embodiment, the tray has two retaining lips 9 that engage the large side 11 that faces away from the tray base 13. In this embodiment, the two retaining lips 9 are separated by the open portion 4. In another embodiment, the tray 2 includes an open top 14 to allows the digital media player 1 to slide into the tray 2. The open top 14 is located on the opposite side of the tray relative to the open portion 4.

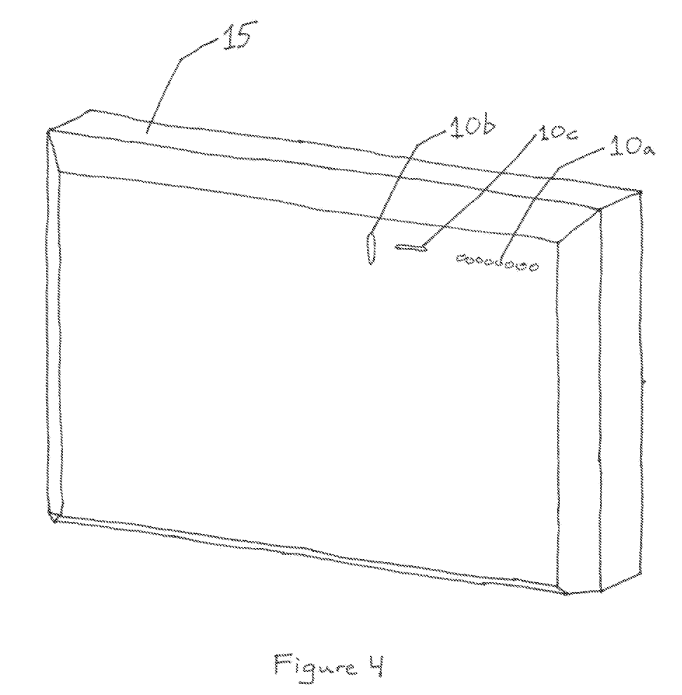

The tray 2 can attach to vents 10 in a screen 15. This mounting method is advantageous because it can be achieved without tools. FIG. 4 shows round vents 10a, vertical vents 10b, and horizontal vents 10c. Screen manufacturers often include vents 10 in the back of the screen 15 to allow heat to escape from inside the screen 15.

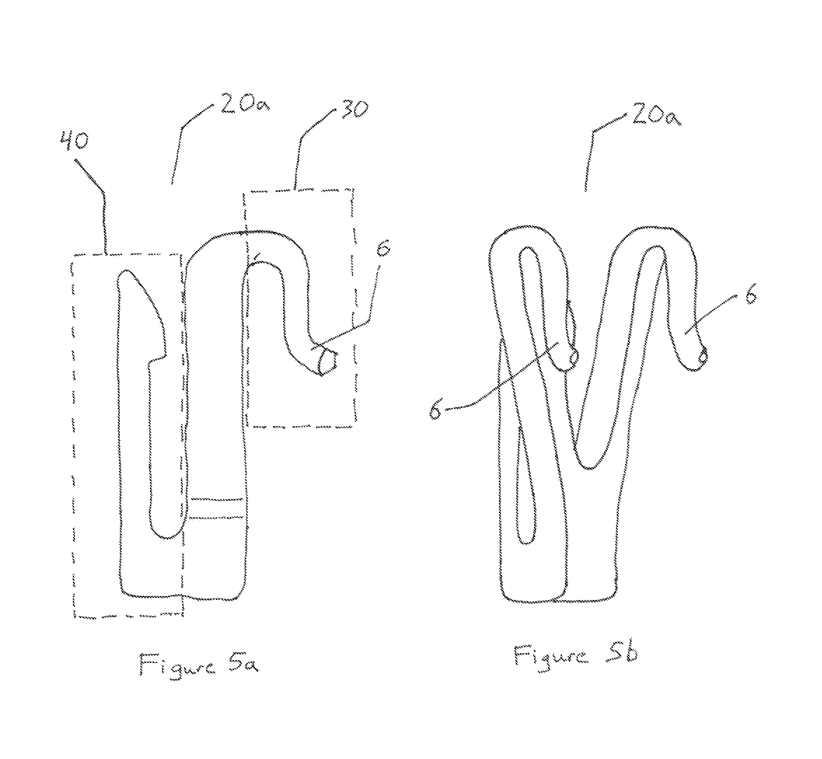

Hooks 20 attach the tray 2 to the vents 10. FIGS. 5a and 5b show a circular hook 20a, which is configured to attach to round vents 10a. In one embodiment, the circular hook 20a has more than one protrusion 6 that enters vents 10. The circular hook 20a has a front portion 30a with a substantially round cross section. The front portion 30 enters into the round vent 10a.

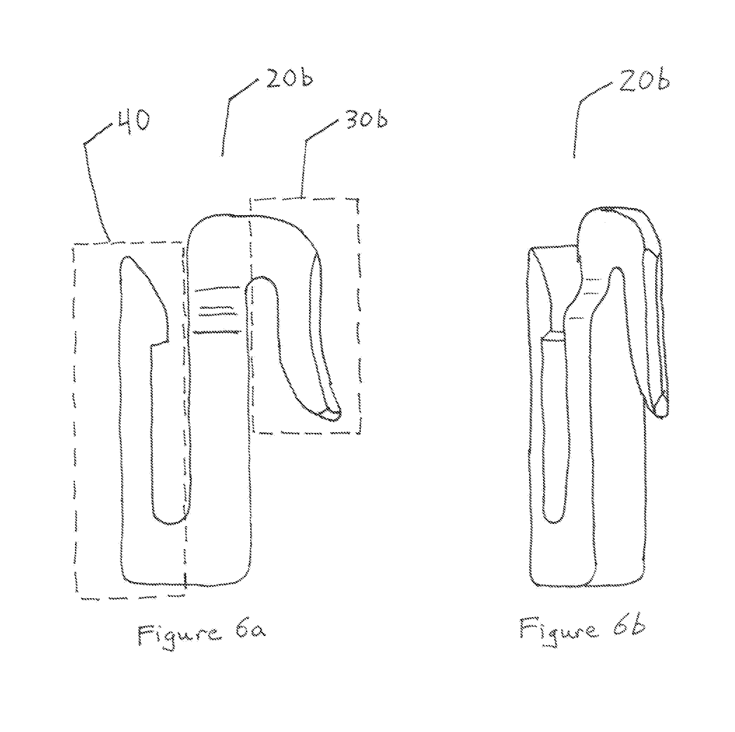

FIGS. 6a and 6b show a vertical hook 20b, which is configured to attach to vertical vents 10b. The cross section of the front portion 30b of the vertical hook 20b that enters the vent 10 is taller than it is wide. In one embodiment, the vertical hook 20b is at least twice as tall as it is wide.

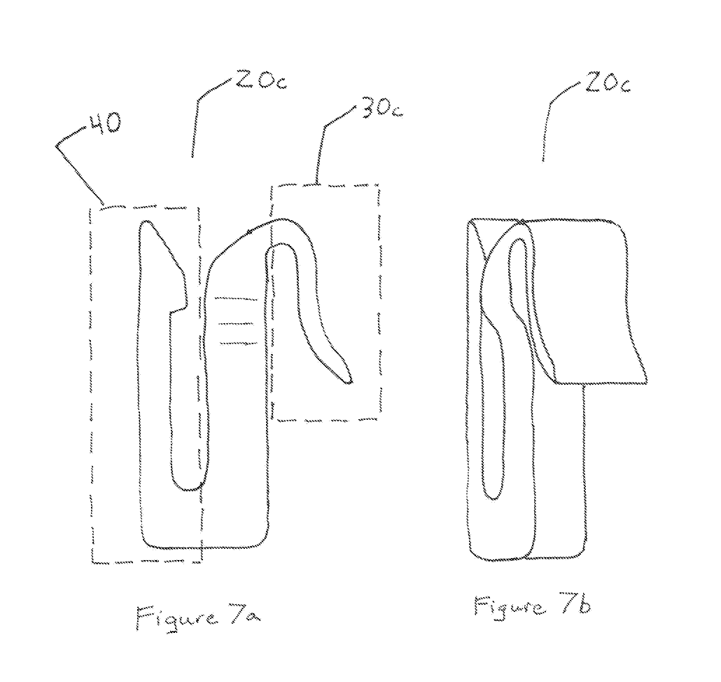

FIGS. 7a and 7b show a horizontal hook 20c, which is configured to attach to horizontal vents 10c. The cross section of the front portion 30c of the horizontal hook 20c that enters the vent is wider than it is tall. In one embodiment, the horizontal hook 20c is at least twice as wide as it is tall.

In one embodiment, the hooks 20 are metal. In another embodiment, the hooks 20 are a non-electrically conductive material such as plastic or rubber.

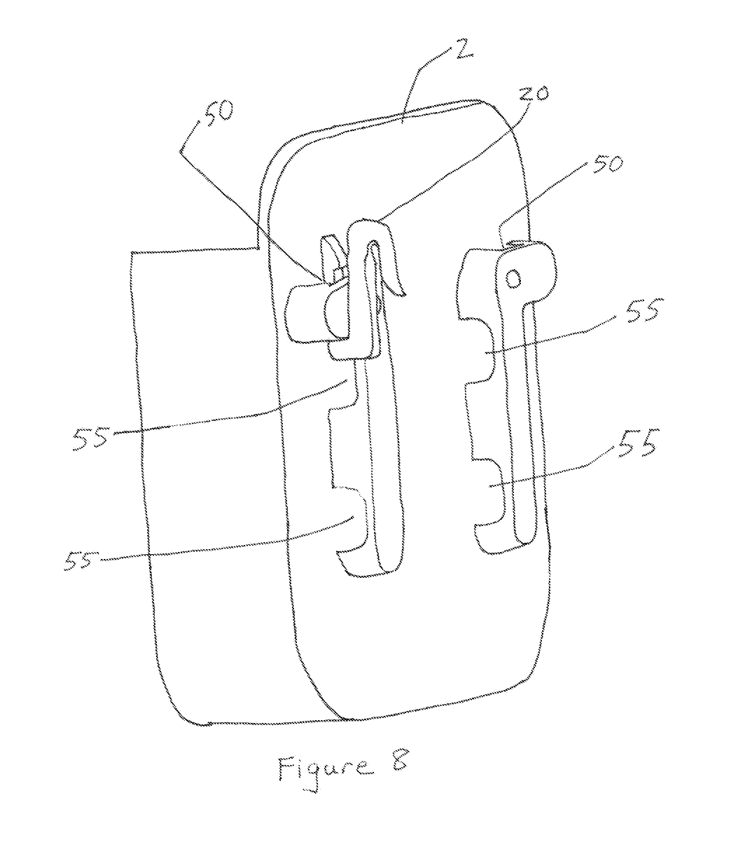

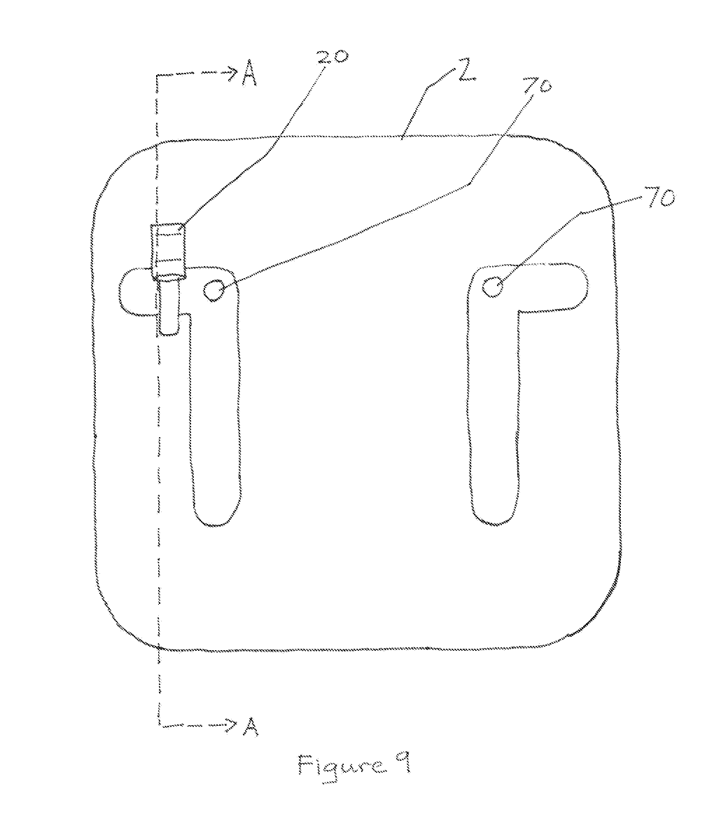

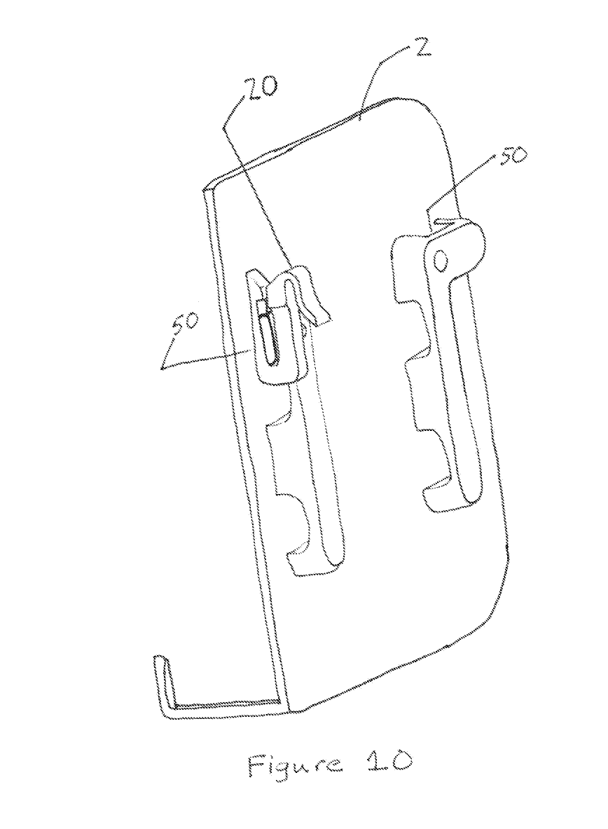

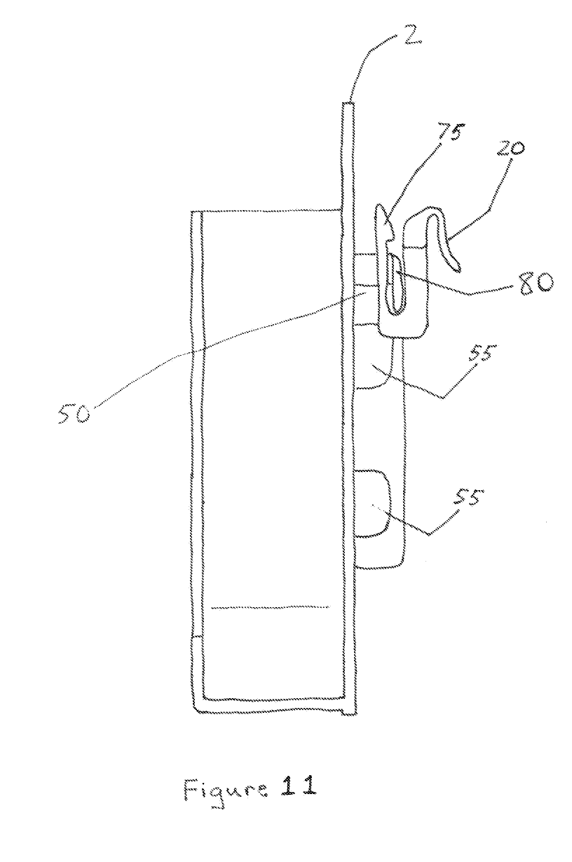

The hooks 20 have a back portion 40, which is configured to attach to the tray 3. FIG. 8 shows an embodiment where the back portion 40 slides into a first opening 50 in the tray 2. FIG. 10 shows cross section A-A from FIG. 9 of the hook 20 in the first opening 50. FIG. 11 illustrates a side view of cross section A-A from FIG. 9 of the hook 20 in the first opening 50.

In one embodiment, the following method is used to attach the tray 2 to the screen 15. The user determines which style of hook 20 is compatible with the vents 10 on her screen 15. The user attaches the hooks 20 to the tray 2. The user attaches the hooks 20 to the vents 10. The user attaches the digital media player 1 to the tray 2. The above steps can be performed in orders different from the order listed above. For example, the user can attach the hooks 20 to the vents 10 before attaching the hooks 20 to the tray 2. In another method, the user attaches the tray 2 to the vents 10 by using hooks 20.

In one embodiment, the tray includes additional openings 55 as illustrated in FIGS. 8 and 11. In one embodiment, the following method is used to mount the tray 2: The user ties the tray 2 to the screen mount 60 using a fastening loop 65.

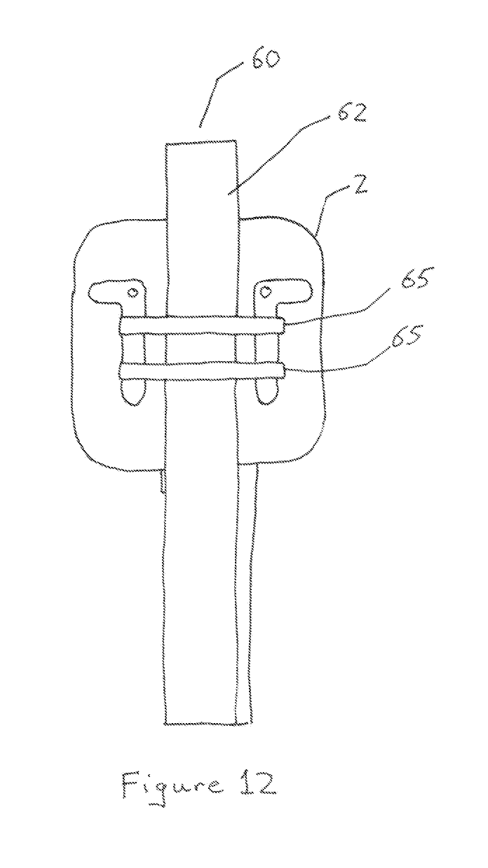

Fastening loops 65 include cable ties, zip ties, ropes, strings, and bands such as Velcro bands. Screen mounts 60 attach screens 15 to walls such as the vertical walls that form the outer perimeter of rooms in a building such as a home or office. Screen mounts 60 often include vertical bars 62 and horizontal bars. In one embodiment, the user ties the tray 2 to the vertical bar 62. In another embodiment, the user ties the tray 2 to the horizontal bar. The user ties the tray 2 to the bar 62 by placing a fastening loop 65 around the bar 62 and through the opening 50, 55. FIG. 12 shows fastening loops 65 securing the tray 2 to the vertical bar 62 by going around the vertical bar 62 and through the additional openings 55.

In another embodiment, the tray 2 also includes screw holes 70 as shown in FIG. 9. In another mounting method, the user places a screw through the screw hole 70, presses the tray 2 against a wall, and then rotates the screw such that the screw advances into the wall to secure the tray 2 to the wall. In another embodiment, the user places a nail through the screw hole 70, presses the tray 2 against a wall, and then pushes the nail's head such that the nail advances into the wall to secure the tray 2 to the wall.

In another embodiment, the tray 2 includes first openings 50, additional openings 55, and screw holes 70 such that the user can mount the tray 2 by attaching the tray 2 to the vents 10 by using hooks 20, can mount the tray 2 by attaching the tray 2 to the bars 62 by using fastening loops 65, or can mount the tray 2 by attaching the tray 2 to the wall by using screws or nails. In a related embodiment, a package in which the tray 2 is sold to customers includes hooks 20, fastening loops 65, and nails. In a related embodiment, the package in which the tray is sold to customers includes hooks 20, fastening loops 65, and screws. Thus, the package is a universal mounting system because it provides means for an extremely wide range of customers to mount their digital media players.

In one embodiment, the hooks 20 attach to the tray 2 via a snap fit. A snap fit is a self-locking joint in which one part flexes until it slips past a second part. Once the part that flexes slips past the second part, the part that flexes returns to substantially its initial shape, which prevents the two parts from inadvertently separating. FIG. 11 shows an embodiment where a flexing part 75 has moved past a second part 80. In the embodiment shown in FIG. 11, the second part 80 forms the outer perimeter of the first opening 50. The snap fit is advantageous because it prevents the hook 20 from inadvertently falling off the tray 2.

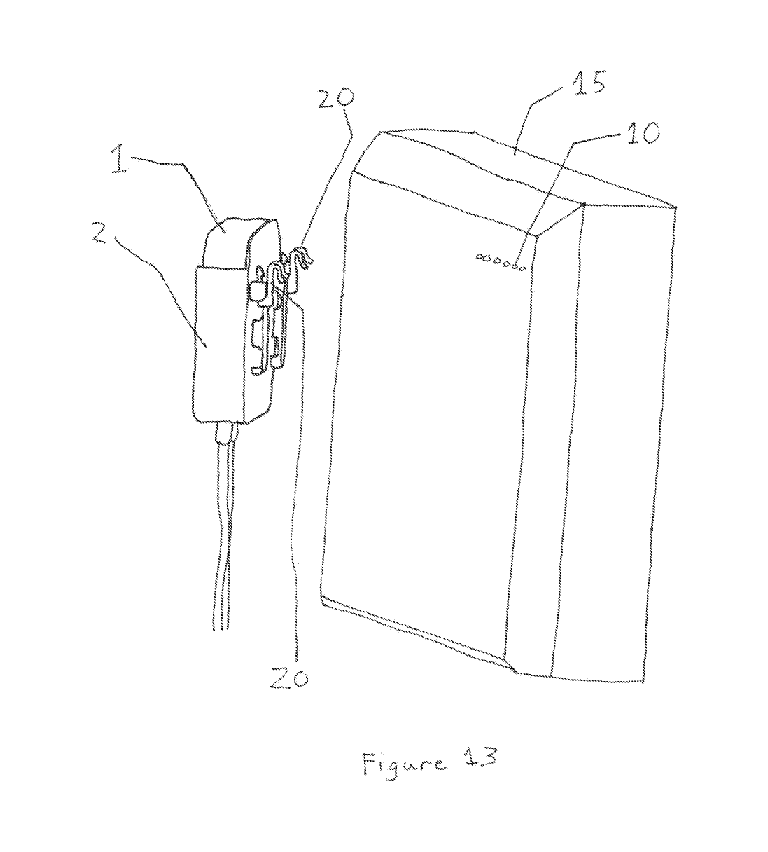

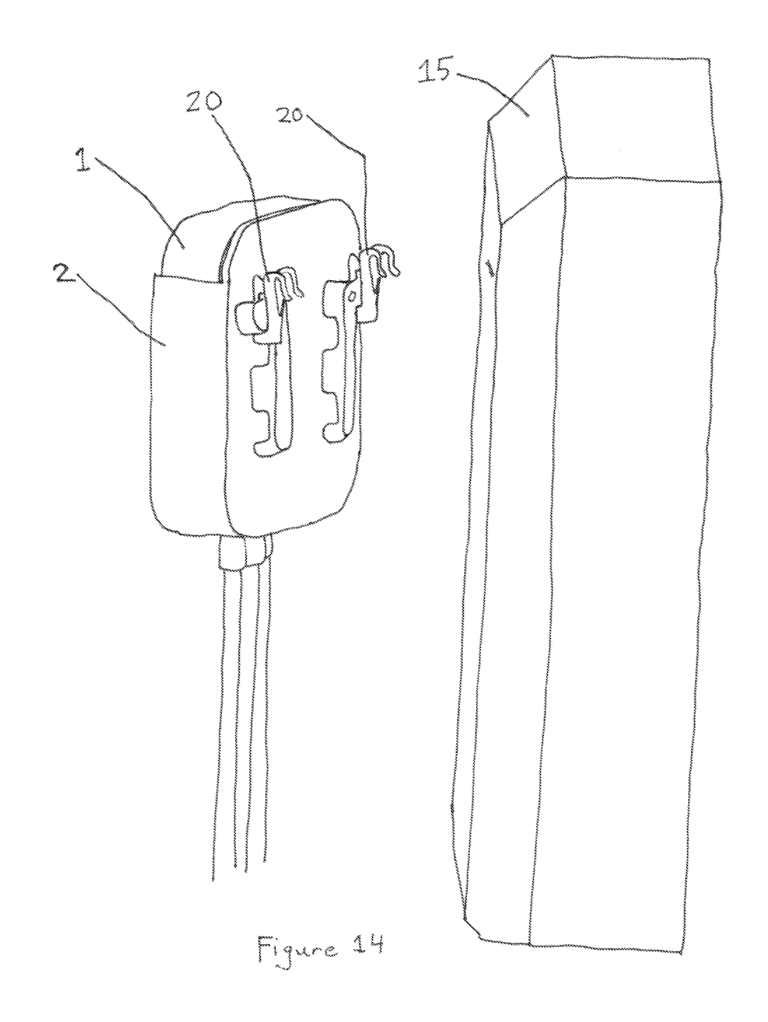

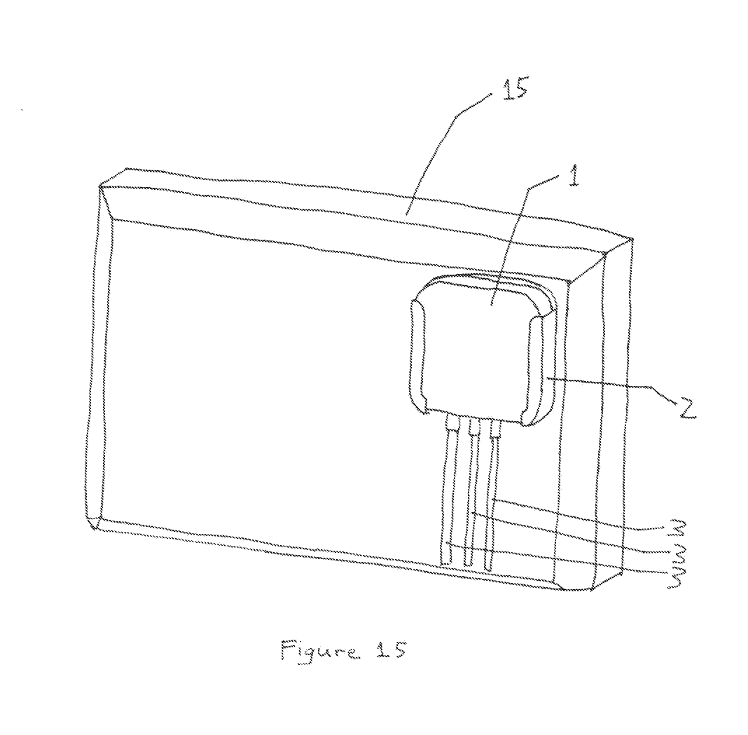

FIGS. 13 and 14 show hooks 20 attached to the tray 2 as the tray 2 approaches the vents 10. FIG. 15 shows the tray 2 mounted on the screen 15 by using the hooks 20.

Many other tray geometries are possible. In another embodiment, the tray 2 includes at least three screw holes 70.

The tray 2 can be molded from acrylonitrile butadiene styrene (ABS) plastic with a hardness of 75 shore D. The hooks 20 can be molded from ABS plastic with a hardness of 75 shore D, from ABS plastic with a hardness of 60 shore D, from polyurethane with a hardness of 90 shore A, or from silicone rubber with a hardness of 95 shore A.

The above description is intended to be illustrative, and not restrictive. For example, the above embodiments and aspects thereof may be used in combination with each other. Many other embodiments will be apparent to those skilled in the art after reading the above description. While the foregoing written description of the invention enables one of ordinary skill to make and use the claimed invention, those of ordinary skill will understand and appreciate the existence of variations, permutations, combinations, equivalent means, and equivalents of the specific embodiments, methods, and examples herein. The invention should therefore not be limited by the above described embodiments, methods, and examples, but by all embodiments and methods within the scope and spirit of the invention as claimed.

We claim:

1. A mount for attaching a digital media player to a screen having vents, comprising:
walls configured to wrap at least partially around the digital media player; and
a vent hook that is coupled to at least one of the walls, the vent hook is configured to attach the mount to at least one of the vents.

2. The mount of claim 1, wherein the vent hook is coupled to at least one of the walls by a snap fit.

3. The mount of claim 1, wherein the vent hook is not electrically conductive.

4. A mounting system for attaching a digital media player to a screen having vents, comprising:
a tray configured to hold the digital media player; and
a vent hook configured to couple to the tray and configured to attach to at least one of the vents.

5. The mounting system of claim 4, wherein the tray comprises sidewalls and retaining lips configured to at least partially enclose the digital media player.

6. The mounting system of claim 5, wherein the tray further comprises an open top to allow the digital media player to slide into the tray.

7. The mounting system of claim 6, wherein the tray further comprises an open portion configured to facilitate the digital media player sliding into the tray when electrical cables are attached to the digital media player.

8. The mounting system of claim 4, wherein the vent hook comprises more than one protrusion that is configured to enter at least one of the vents.

9. The mounting system of claim 4, wherein the vent hook comprises a front portion that is configured to enter at least one of the vents, and a cross section of the front portion is taller than the cross section is wide.

10. The mounting system of claim 4, wherein the vent hook comprises a front portion that is configured to enter at least one of the vents, and a cross section of the front portion is wider than the cross section is tall.

11. The mounting system of claim 4, wherein the mounting system further comprises a first vent hook that comprises a front portion having a substantially round cross section; a second vent hook that comprises a front portion having a cross section that is taller than the cross section is wide; and a third vent hook that comprises a front portion having a cross section that is wider than the cross section is tall.

12. The mounting system of claim 4, wherein the tray comprises a first opening, the vent hook comprises a back portion that is configured to slide into the first opening, and the vent hook is coupled to the tray by a snap fit.

13. The mounting system of claim 4, wherein the mounting system comprises a fastening loop configured to attach the tray to a screen mount, and the tray further comprises an additional opening configured to allow the fastening loop to pass through the additional opening and around at least a portion of the screen mount.

14. The mounting system of claim 4, wherein the mounting system comprises a screw and the tray further comprises a screw hole.

15. A method for mounting a digital media player to a screen having a vent, comprising:
attaching a hook to a tray;
attaching the hook to the vent of the screen; and
attaching the digital media player to the tray.

16. The method of claim 15, further comprising determining which hook style is compatible with the vent.

17. The method of claim 15, wherein the hook and the tray are molded.
